(19) United States
(12) Patent Application Publication
(10) Pub. No.: US 2006/0143171 A1
(43) Pub. Date: Jun. 29, 2006

(54) System and method for processing a text search query in a collection of documents

(75) Inventors: Jochen Doerre, Boeblingen (DE); Monika Matschke, Calw. (DE); Roland Seiffert, Herrenberg (DE)

Correspondence Address: SAMUEL A. KASSATLY LAW OFFICE, 20690 VIEW OAKS WAY, SAN JOSE, CA, 95120, US

(73) Assignee: International Business Machines Corporation

(21) Appl. No.: 11/303,835

(22) Filed: Dec. 16, 2005

(30) Foreign Application Priority Data
Dec. 29, 2004 (EP) 04107041.8

(51) Int. Cl. G06F 17/30

(52) U.S. Cl. 707/5

(57) ABSTRACT

The present system processes a text search query on a collection of documents in which a text search query is translated into conditions on index terms. The system groups documents in blocks of N and generates and stores a block posting index enumerating blocks in which the index term occurs in at least one document of the block. The system generates and stores intrablock postings for each block and each index term. The intrablock postings comprise a bit vector of length N representing the sequence of documents forming the block. Each bit indicates the occurrence of the index term in the corresponding document. The conditions of a given query are processed using the block posting index to obtain hit candidate blocks and identify the hit documents fulfilling the conditions.

### PRIORITY CLAIM

The present application claims the priority of European patent application titled “Method and Infrastructure for Processing a Text Search Query in a Collection of Documents,” Ser. No. 04107041.8, filed on Dec. 29, 2004, which is incorporated herein in its entirety.

### FIELD OF THE INVENTION

The present invention generally relates to a method and an infrastructure for processing text search queries in a collection of documents. Particularly, the present invention utilizes current process features such as single instruction multiple data (SIMD) units to further optimize Boolean query processing.

### BACKGROUND OF THE INVENTION

Text search in the context of database queries is becoming more and more important—most notably for XML processing. Current text search solutions tend to focus on “stand-alone systems”.

The purpose of a text search query is usually to find those documents in a collection of documents that fulfil certain criteria or search conditions, such as that the document contains certain words. In many cases, the “relevance” of documents fulfilling the given search conditions is calculated as well by using a process called scoring. Most often, users are only interested in seeing the “best” documents as result of a text search query. Consequently, most search technology aims at producing the first N best results for relatively simple user queries as fast as possible.

In the context of database queries, especially to support XML, queries are complex, i.e. expressing many conditions, and all results are needed for combination with conditions on other database fields. As the size of document collections to be searched is constantly increasing, efficiency of text search query processing becomes an ever more important issue.

Text search query processing for full text search is usually based on “inverted indexes”. To generate inverted indexes for a collection of documents, all documents are analysed to identify the occurring words or search terms as index terms together with their positions in the documents. In an “inversion step” this information is basically sorted so that the index term becomes the first order criteria. The result is stored in a posting index comprising the set of index terms and a posting list for each index term of the set.

Most text search queries comprise Boolean conditions on index terms that can be processed by using an appropriate posting index.

Although this technology has proven to be useful, it would be desirable to present additional improvements to improve search performance. What is therefore needed is a system, a computer program product, and an associated method for processing a text search query in a collection of documents that performs well, especially for complex queries returning all results.

### SUMMARY OF THE INVENTION

The present invention satisfies this need, and presents a system, a computer program product, and an associated method (collectively referred to herein as “the system” or “the present system”) for processing a text search query in a collection of documents (further referenced herein as a document collection or collection).

A text search query of the present system comprises search conditions on search terms, the search conditions being translated into conditions on index terms. The documents of the document collection are grouped in blocks of N documents, respectively, before a block posting index is generated and stored. The block posting index comprises a set of index terms and a posting list for each index term of the set, enumerating all blocks in which the index term occurs at least once. Further, intrablock postings are generated and stored for each block and each index term. The intrablock postings comprise a bit vector of length N representing the sequence of documents forming the block, wherein each bit indicates the occurrence of the index term in the corresponding document. The conditions of a given query are processed by using the block posting index to obtain hit candidate blocks comprising documents that are candidates for fulfilling the conditions, evaluating the conditions on the bit vectors of the hit candidate blocks to verify the corresponding documents, and identifying the hit documents fulfilling the conditions.

The present system groups the documents of the collection in blocks to treat N documents together as a single block. Consequently, a block posting index is generated and stored for the blocks of the collection. In the context of this block posting index, a block comprising N documents takes the role of a single document in the context of a standard inverted index.

The block posting index according to the present system does not comprise any positional or occurrence information, thus allowing a quick processing of search conditions that do not require this kind of information, like Boolean conditions.

The present system evaluates the conditions of a given query by using the block posting index. Thus, it is possible to identify all blocks of the collection comprising a set of one or more documents fulfilling the conditions when taken together. That is, the resultant “hit candidate” blocks may but do not necessarily comprise a hit document. Consequently, processing the conditions of a given query on the block posting index has a certain filter effect as this processing reduces significantly the number of documents to be searched.

The present system validates the individual documents forming the “hit candidate” blocks. Therefore, the index structure of the present system comprises intrablock postings for each block of the collection and for each index term of the block posting index. The data structure of these intrablock postings comprises a bit vector for each block and each index term. This data structure allows a fast processing of the relevant information to validate the individual “hit candidate” documents.

There are different possibilities to perform the evaluation on the bit vectors. For example, the present system may evaluate the bit vectors bit by bit. In one embodiment, the bit vector structure of the here relevant information is used for parallel processing. Therefore, a single instruction multiple data (SIMD) unit can be used to take advantage of current hardware features.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a diagram illustrating an infrastructure of a text search query processing system of the present invention further illustrating a process flow for generating an index structure according to the present invention;

FIG. 2 is a diagram illustrating an exemplary index structure according to the present invention; and

FIG. 3 is a process flow chart illustrating a method for processing a text search query according to the present invention.

### DETAILED DESCRIPTION OF PREFERRED EMBODIMENTS

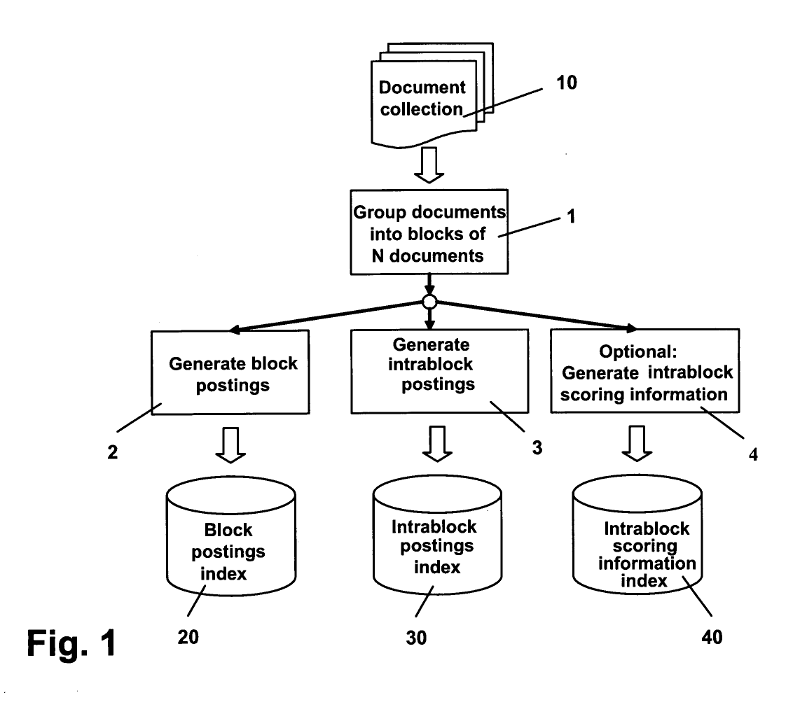

FIG. 1 illustrates an infrastructure required for implementing the present invention and further illustrates a process flow for generating an index structure according to the present invention. A text search query is carried out on a given document collection 10 (further referenced herein as a collection of documents 10). All documents of the document collection 10 are grouped into blocks of N documents (step 1) using appropriate grouping method (not shown). By choosing the block size N, advantage can be taken of hardware features available in the infrastructure, e.g. SIMD (single instruction multiple data) extensions such as, for example, SSE2 in Intel/AMD processors or VMX in PowerPC processors. N may be chosen as vector length of the unit or one of its multiples. In case of an SIMD unit, N=128 is an appropriate block size, i.e., each block represents 128 consecutive documents of the document collection 10.

Block posting lists are generated for each index term of a set of index terms (step 2), wherein each block posting list enumerates all blocks in which the corresponding index term occurs. The block posting lists may further comprise additional information, such as, for example, the number of occurrences of the corresponding index term for all blocks enumerated. These block posting lists are stored in a block posting index 20. The block posting index 20 is an inverted index. Consequently, the block posting index 20 may be generated as described above in connection with the state of the art wherein each block takes the role of a document. In one embodiment of the present invention, the block posting index 20 is generated by using an already existing index structure, such as, for example, a full posting index enumerating all occurrences of all index terms in all documents of the document collection 10. In any case, an appropriate method (not shown) is used for generating and storing the block posting index 20.

Beside the block posting index 20, intrablock postings are generated for each block (step 3) and each index term and are stored in an intrablock posting index 30. Each intrablock posting comprises a bit vector of length N representing the sequence of documents forming the block. Each bit of the bit vector indicates whether the index term related to the intrablock posting occurs in the document corresponding to the bit. The procedure of generating the intrablock postings (step 3) implies that the infrastructure according to the invention comprises an appropriate method for generating the bit vectors of length N.

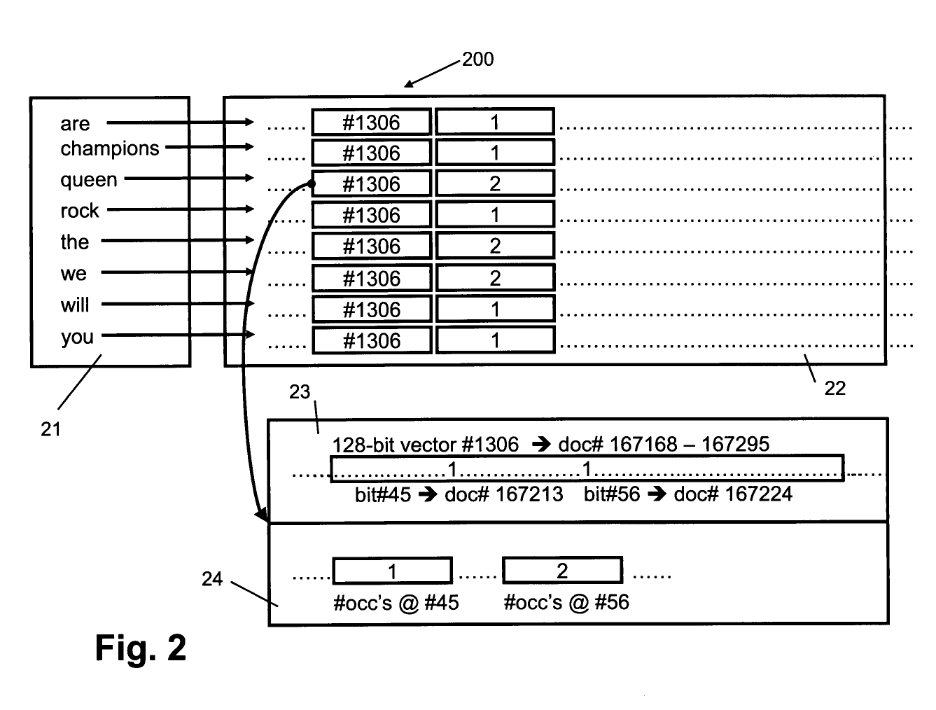

Intrablock scoring information is generated in step 4. This implies that the infrastructure according to the invention comprises appropriate method for generating the scoring information. An example for intrablock scoring information will be described in connection with FIG. 2. This intrablock scoring information is stored in a separate data structure designated as intrablock scoring information index 40.

The example illustrated in FIG. 2 refers to a text search query based on a set of index terms 21 comprising “are, champions, queen, rock, the, we, will, you”. The block posting index 200, only partly shown, uses the set of index terms 21 as order criteria; block posting lists 22 are related to the index terms in the set of index terms 21, respectively. Exemplarily, only one entry of the block posting lists is specified in each block posting list 22, namely the one of block 1306. In addition to the information that the related index term occurs in at least one of the documents of block 1306, the block posting lists 22 of the here described example comprise the number of occurrences of the index term in the block 1306.

FIG. 2 further illustrates, at least partly, intrablock postings 23 and an intrablock scoring information 24 for block 1306 and the index term “queen”. Block 1306 comprises the 128 consecutive documents 167168 to 167295 of the document collection 10. The intrablock postings 23 comprise a 128 bit vector. Each bit of this vector represents one of the documents 167168 to 167295. A “1” at position 45 and position 56 indicates that the 45th and the 56th document, which are documents 167213 and 167224, contain the index term “queen”.

The intrablock scoring information 24 is stored in a separate data structure. The number of occurrences of index term “queen” in a document is used as intrablock scoring information, which is 1 for the 45th document, i.e. document 167213, and 2 for 56th document, i.e. document 167224 of the document collection 10. Any type of scoring information may be stored in the intrablock scoring index; the here described embodiment is just an example for one possibility of implementing the present invention.

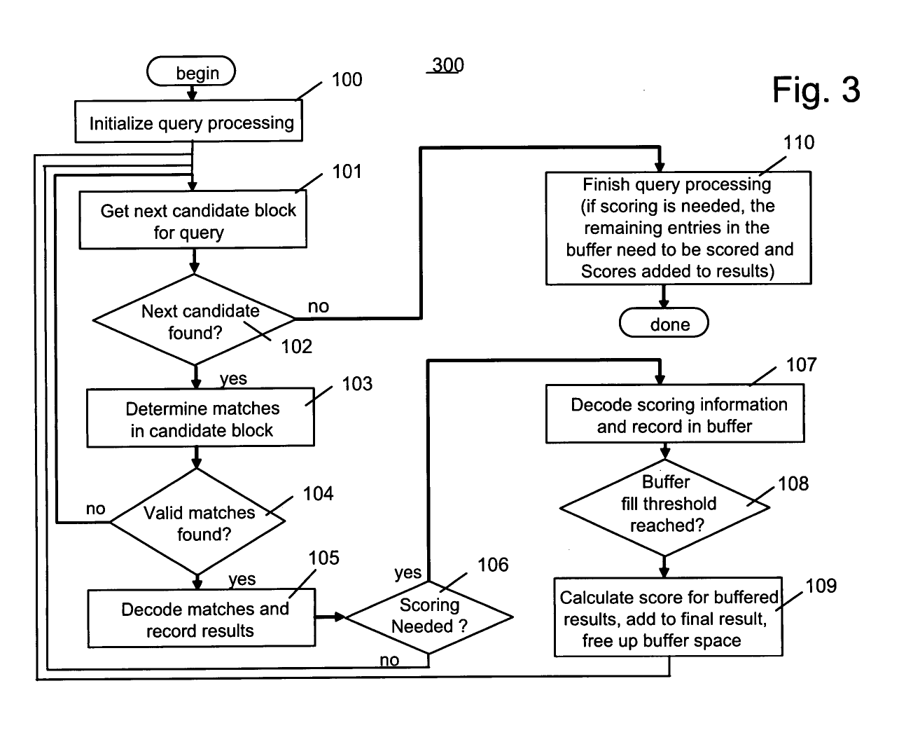

The flowchart of FIG. 3 illustrates a method 300 for processing a text search query in the document collection 10, which uses an index structure as shown in FIGS. 1 and 2 and described above in detail. Method 300 illustrates how to validate the hit candidate blocks according to the invention, which identifies the hit documents of the document collection 10. Therefore, the intrablock posting index is used, which will be described in connection with steps 100 to 105 of the flow chart.

Processing a text search query in the document collection 10 is initiated by translating the search conditions of the query into conditions on the index terms of the index structure used. The infrastructure for processing a text search query comprises a method for translating the search conditions on search terms of a given text search query into conditions on index terms.

Query processing is initialized (step 100) which comprises among other procedures the translation of the search conditions into conditions on index terms.

Processing enters a loop at step 101. A next hit candidate block is retrieved (step 101). Retrieving the next hit candidate block comprises evaluating the query conditions by using the block posting index. Consequently, the query is not evaluated for a single document but for the blocks of the document collection 10. This processing can be performed using any of the well-known query processing methods on inverted index structures. The result of this evaluation is a hit candidate block comprising at least a set of documents fulfilling the conditions when taken together, i.e., a hit candidate block does not necessarily comprise a single hit document.

Step 102 verifies whether a next hit candidate block has been found. If not, query processing is finished (step 110). If a next hit candidate block has been found, the matches are determined in the hit candidate block (step 103), evaluating the conditions of the query on the corresponding bit vectors of the intrablock posting index.

Step 104 checks whether valid matches, i.e. hit documents, are found. If the intrablock postings have the form of 128-bit vectors, a complete 128-bit vector can be processed in one step by using an SIMD unit. If no SIMD unit is available, a 128-bit vector can be processed by four 32-bit units on a 32-bit architecture or by two 64-bit units on a 64-bit architecture. However, even without an SIMD unit, this evaluation scheme may be beneficial due to good cache locality. If the result vector is zero, no hit document has been found in the block and processing returns to step 101. If the result vector is non-zero at least one hit has been validated successfully. The non-zero bit positions are decoded to determine the hit documents and the results are stored (step 105). Hereby, a hit candidate block is validated and the hit documents within the block are identified.

Query processing further comprises the possibility of scoring the identified hit documents. Therefore, step 106 determines whether scoring is needed. If not, processing returns to step 101.

In case that scoring is needed, the intrablock scoring index is accessed to decode the intrablock scoring information of the hit document. This scoring information is recorded in a buffer (step 107). The buffer is used to accumulate the scoring information for several hit documents. In one embodiment, the buffer may be managed as a round-robin queue. Step 108 determines whether a buffer fill threshold is reached. If so, the score for all buffered results is calculated (step 109). Thus, the score calculation can be vectorized using appropriate hardware features available in the infrastructure, because the score calculation requires that the same mathematical formula is evaluated on the scoring information for each hit document.

If, for example, calculation is performed using 32-bit float values then a 128-bit SIMD unit can evaluate the same formula on four complete sets of scoring information in parallel. If no SIMD unit or alternative vector processor is available, this processing is performed element-wise. However, even without an SIMD unit, this evaluation scheme may be beneficial due to good cache locality. The results of the score calculation are added to the results as a block instead of individual inserts. The buffer space is freed up and processing returns to step 101.

The content of FIG. 3 can also be expressed by the following exemplary program code:

init (Query);
while current_match_candidate = next_match_candidate( ) {

if matches = verify(current_match_candidate) {

decode_and_queue(matches);
if match_queue.count > threshold {

// score threshold matches
// add result/score to global result
// remove scored result entries from queue

}

}

}
sort_result( );

Method 300 is particularly suitable for complex Boolean queries returning all results. Complex queries with high-frequent terms and non-ranked queries also benefit. The block-based Boolean filtering proposed by the invention is efficient for many typical queries in database context. Only modest changes to the existing code are necessary to implement the invention. The new index data structure can be generated from current indexes.

It is to be understood that the specific embodiments of the invention that have been described are merely illustrative of certain applications of the principle of the present invention. Numerous modifications may be made to the system and method for processing a text search query in a collection of documents described herein without departing from the spirit and scope of the present invention.

What is claimed is:

1. A processor-implemented method for processing a text search query in a collection of documents, wherein the text search query comprises search conditions on search terms, and wherein the search conditions are translated into conditions on index terms, the method comprising:
grouping the collection of documents in blocks of N documents;
generating a block posting index, wherein the block posting index comprises a set of the index terms and a posting list for each index term of the set of the index terms;
enumerating all blocks in which each index term occurs;
generating intrablock postings for each block and each index term, wherein the intrablock postings comprise a bit vector of length N representing a sequence of the documents forming the block, wherein each bit indicates an occurrence of the index term in a corresponding document; and
processing the conditions on the index terms of the query by:
using the block posting index to obtain hit candidate blocks comprising documents being candidates for fulfilling the conditions,
evaluating the conditions on the bit vectors of the hit candidate blocks to verify the corresponding documents; and
identifying hit documents fulfilling the conditions.

2. The method according to claim 1, wherein evaluating the bit vectors includes evaluating using parallel processing.

3. The method according to claim 1, wherein evaluating the bit vectors includes using a single instruction multiple data, SIMD, unit to evaluate the bit vectors.

4. The method according to claim 1, wherein the block posting index comprises additional information including a number of occurrences for each index term and each block.

5. The method according to claim 1, further comprising generating intrablock score information in a separate data structure.

6. The method according to claim 5, wherein the hit documents identified for a given query are scored using the intrablock score information.

7. The method according to claim 6, wherein generating the intrablock score information includes calculating score information; and
further comprising accumulating the intrablock score information of a plurality of hit documents in a buffer in order to calculate the score information.

8. The method according to claim 7, wherein calculating the score information includes using a single instruction multiple data, SIMD, unit to calculate the intrablock score information.

9. A processor-implemented infrastructure for processing a text search query in a collection of documents, wherein the text search query comprises search conditions on search terms, and wherein the search conditions are translated into conditions on index terms, the infrastructure comprising:
the collection of documents being grouped in blocks of N documents;
a block posting index comprising a set of the index terms and a posting list for each index term of the set of the index terms, wherein all the blocks in which each index term occurs are enumerated;
intrablock postings being generated for each block and for each index term, wherein the intrablock postings comprise a bit vector of length N representing a sequence of the documents forming the block, wherein each bit indicates an occurrence of the index term in a corresponding document; and
wherein the conditions on the index terms of the query are processed by:
using the block posting index to obtain hit candidate blocks comprising documents being candidates for fulfilling the conditions,
evaluating the conditions on the bit vectors of the hit candidate blocks to verify the corresponding documents; and
identifying hit documents fulfilling the conditions.

10. The infrastructure according to claim 9, wherein the bit vectors are evaluated using parallel processing.

11. The infrastructure according to claim 9, wherein the bit vectors are evaluated using a single instruction multiple data, SIMD, unit.

12. The infrastructure according to claim 9, wherein the block posting index comprises additional information including a number of occurrences for each index term and each block.

13. The infrastructure according to claim 9, wherein intrablock score information is generated in a separate data structure.

14. The infrastructure according to claim 13, wherein the hit documents identified for a given query are scored using the intrablock score information.

15. The infrastructure according to claim 14, wherein the intrablock score information of a plurality of hit documents are accumulated in a buffer in order to calculate score information.

16. The infrastructure according to claim 15, further comprising a single instruction multiple data, SIMD, unit to calculate the score information.

17. A computer program product having program codes stored on a computer-usable medium for processing a text search query in a collection of documents, wherein the text search query comprises search conditions on search terms, and wherein the search conditions are translated into conditions on index terms, the computer program product comprising:
a program code for grouping the collection of documents in blocks of N documents;
a program code for generating a block posting index, wherein the block posting index comprises a set of the index terms and a posting list for each index term of the set of the index terms;
a program code for enumerating all blocks in which each index term occurs;
a program code for generating intrablock postings for each block and each index term, wherein the intrablock postings comprise a bit vector of length N representing a sequence of the documents forming the block, wherein each bit indicates an occurrence of the index term in a corresponding document; and
a program code for processing the conditions on the index terms of the query by:
using the block posting index to obtain hit candidate blocks comprising documents being candidates for fulfilling the conditions,
evaluating the conditions on the bit vectors of the hit candidate blocks to verify the corresponding documents; and
identifying hit documents fulfilling the conditions.

18. The computer program product according to claim 17, wherein the program code for evaluating the bit vectors evaluates the bit vectors using parallel processing.

19. The computer program product according to claim 17, wherein the program code for evaluating the bit vectors uses a single instruction multiple data, SIMD, unit to evaluate the bit vectors.

20. The computer program product according to claim 17, wherein the block posting index comprises additional information including a number of occurrences for each index term and each block.

21. The computer program product according to claim 17, further comprising a program code for generating intrablock score information in a separate data structure.

22. The computer program product according to claim 21, wherein the hit documents identified for a given query are scored using the intrablock score information.

23. The computer program product according to claim 22, wherein the intrablock score information includes score information; and
further comprising a program code for accumulating the intrablock score information of a plurality of hit documents in a buffer in order to calculate the score information.

24. The computer program product according to claim 23, wherein the score information are calculated using a single instruction multiple data, SIMD, unit to calculate the intrablock score information.
